(19) United States
(12) Patent Application Publication
(10) Pub. No.: US 2015/0070755 A1
(43) Pub. Date: Mar. 12, 2015

(54) SOLAR CONTROL GLAZING

(71) Applicant: SAINT-GOBAIN GLASS FRANCE, Courbevoie (FR)

(72) Inventors: Laura Jane Singh, Paris (FR); Augustin Palacios-Laloy, Paris (FR); Etienne Sandre-Chardonnal, Paris (FR)

(73) Assignee: SAINT-GOBAIN GLASS FRANCE, Courbevoie (FR)

(21) Appl. No.: 14/386,451

(22) PCT Filed: Mar. 8, 2013
(86) PCT No.: PCT/FR2013/050490

§ 371 Date: Sep. 19, 2014

(30) Foreign Application Priority Data
Mar. 21, 2012 (FR) 12 52523

(51) Int. Cl. G02B 5/20; G02B 1/10

(52) U.S. Cl. CPC G02B 5/208; G02B 1/105
USPC 359/359

(57) ABSTRACT

The invention relates to a solar control glazing comprising a glass substrate provided, on one of its faces, with a stack of layers having a solar protection function, in which the stack comprises the sequence of the following layers, starting from the surface of the glass substrate: a lower layer for protecting the upper layers against the migration of the alkali metal ions resulting from the glass substrate, a layer of an indium tin oxide (ITO), an upper layer for protecting the ITO layer against atmospheric oxygen, said glazing being characterized in that said upper and lower layers are essentially composed of a dielectric material chosen from a silicon nitride, an aluminum nitride or their mixture and in that intermediate layers made of a chromium-comprising metal, which layers are optionally partially or completely oxidized and/or nitrided, are positioned on either side of and in contact with said ITO layer, the thickness of said intermediate layers being between 0.5 and 3 nanometers.

The invention relates to the field of glass substrates or articles, in particular of the building or motor vehicle glazing type, comprising, at their surface, coatings obtained by the stacking of a sequence of thin layers, conferring on them solar control properties, in particular solar protection properties. The term “glazing” is understood to mean, within the meaning of the present invention, any glass product composed of one or more glass substrates, in particular single glazings, double glazings, triple glazings, and the like. The term “solar protection” is understood to mean, within the meaning of the present invention, the ability of the glazing to selectively limit the incident radiant flux, in particular infrared (IR) radiation resulting from solar radiation, passing through it from the outside toward the inside of the dwelling or compartment, while retaining a sufficient light transmittance, that is to say a light transmittance typically of greater than 40%, indeed even 50% or even 55%. More particularly, the present invention relates to glazings provided with stacks, the functional or active layer of which, that is to say the layer conferring the main part of such properties on said stack, is composed of an indium tin oxide, often known as ITO in the field.

Such glazings provided with stacks of thin layers thus act on the solar radiation and make possible solar protection and/or thermal insulation. These coatings are conventionally deposited by deposition techniques of the CVD type for the simplest or generally at the current time by techniques for deposition by vacuum sputtering of a target, often known as magnetron sputtering in the field, in particular when the coating is composed of a more complex stack of successive layers.

Generally, the stacks made of thin layers having solar control properties comprise one, indeed even several, active layers. The term “active layer” is understood to mean a layer which acts substantially on the flux of solar radiation passing through said glazing. Such an active layer, in a known way, can operate either mainly in mode of reflection of the infrared radiation or mainly in mode of absorption of the infrared radiation.

In particular, the most efficient stacks currently sold incorporate at least one metal layer of the silver type operating essentially on the mode of the reflection of the IR radiation. These stacks are generally described as low emissivity (low-e) stacks. However, these layers are very sensitive to moisture and are thus exclusively used in double glazings, on face 2 or 3 of the latter, in order to be protected from moisture. The stacks according to the invention do not comprise such layers.

The patents and patent applications U.S. Pat. No. 5,800,933, EP 456 487 A2, EP 560 534 A1 and EP 622 645 A1 describe stacks of intermediate NiCr or Ni layers surrounding a low-emissivity silver layer. According to these publications, the use of such intermediate layers makes it possible to solve the problems of adhesion of the Ag metal layer to the dielectric layers positioned on either side of the stack, as is also indicated in the publication “Airca Coating Technology, Proceedings of the 2^{nd} Coating Technology Symposium, Mar. 12-14, 1990”.

Other metal layers having a solar protection function have also been described in the field, comprising functional layers of the Nb, Ta or W type or nitrides of these metals, such as described, for example, in the application WO 01/21540. However, within such layers, the solar radiation is this time absorbed but nonselectively, that is to say that the IR radiation (in particular that for which the wavelength is between approximately 780 nm and 2500 nm) and the visible radiation are equally absorbed nonselectively. Such glazings thus exhibit selectivities, as illustrated by the T_{L}/g ratio, of less than or at the best of approximately 1.

According to the invention and conventionally, the selectivity is equal to the light transmittance factor/solar factor g ratio, as are determined according to the international standard ISO 9050 (2003).

In a known and conventional way, in the preceding ratio, the light transmittance factor (often known as light transmittance T_{L}) corresponds to the incident radiant flux, that is to say within the wavelength range 380 to 780 nm, passing through the glazing, according to the illuminant D₆₅ and according to the specific criteria in the international standard ISO 9050 (2003).

In a known way, in the preceding ratio, the solar factor SF, also often known as g, is equal to the ratio of the energy passing through the glazing (that is to say, entering the premises) to the incident solar energy. More particularly, it corresponds to the sum of the flux transmitted directly through the glazing and of the flux absorbed by the glazing (including therein the stacks of layers possibly present at one of its surfaces) and then reemitted toward the inside (the premises). The solar factor is also determined according to the instructions described in the international standard ISO 9050 (2003).

Generally, all the light characteristics presented in the present description are obtained according to the principles and methods described in the international standard ISO 9050 (2003) relating to the determination of the light and solar characteristics of the glazings used in glass for the construction industry.

The patent application US 2009/0320824 describes alternatively stacks based on the use of layers of tin-doped indium (ITO) as barrier layer to infrared radiation. According to this publication, the affixing of a layer made of silicon oxide SiO₂ or of silicon nitride Si₃N₄ above the ITO layer substantially improves the durability of the stack when the latter is subjected to temperatures which can range up to 500° C. Likewise, it is indicated that the insertion of a layer made of silicon oxide SiO₂ or of silicon nitride Si₃N₄ below the ITO layer makes it possible to prevent the migration of the alkali metals from the substrate toward the ITO layer and thus its deterioration. The use of layers made of silicon oxide, with a minimum thickness equal to but generally much greater than 100 nm, as is indicated in this publication, presents, however, a problem of economic profitability, due to the excessively low rate of deposition of the SiO₂ layer by the “magnetron cathode sputtering” technique. The use of layers made of silicon nitride thus appears preferable from an economic viewpoint, its rate of deposition being approximately three times greater than that of silicon oxide. However, as will be explained in more detail subsequently, the studies of the applicant company have shown that the use of such nitride-comprising layers, in particular if the glazing provided with the stack has to undergo a heat treatment at a high temperature, is reflected by the appearance of a haze on the glazing, which renders it unsuitable in particular for use as building glazing. In addition, it has been found that such a stack exhibits mechanical strength properties which are manifestly inadequate, in particular with regard to scratching, as will be described in the continuation of the present description.

The main aim of the present invention is first of all to provide glazings comprising a stack of layers which confers on them solar control properties and in particular properties of reflection of the infrared radiation of the solar radiation, but which exhibits a high selectivity, within the meaning described above, that is to say a T_{L}/g ratio of greater than 1.1 or even greater than 1.2, said stack furthermore being durable over time without specific precautions.

Another aim of the present invention is to provide solar control glazings, the stack of layers of which is capable, in particular after a heat treatment, such as a tempering or a bending, of retaining sufficiently high T_{L} values for use as “clear” glazing and in particular a T_{L} of the order of at least 40%, in particular of the order of at least 50% and ideally of greater than 55%, without significant deterioration in the properties of reflection of the IR radiation of the stack.

Thus, according to another aspect of the present invention, a heat treatment on the glazing is generally necessary in order to make possible the improvement in the properties of reflection of the IR radiation of the face of the glazing provided with the stack of layers, as are measured by the normal emissivity ∈_{N} described in the standard ISO 10292 (1994), Annex A. In a well known way, for example described in the reference publication “Les techniques de l'ingénieur, Vitrage a isolation thermique renforcée [Reinforced Thermal Insulation Glazing], C3635 (2004)”, this reflection property is directly a function of the emissivity of the face of the glazing provided with the stack comprising the IR reflecting layer. In particular, in a known way, the functional layers according to the invention, of the ITO (Indium Tin Oxide) type, after their deposition by cathode sputtering, generally have to undergo a heat treatment at temperatures of the order of 620° C. for a few minutes in order to improve the crystallinity thereof and thus to reduce the emissivity thereof. The invention thus provides glazings, the normal emissivity ∈_{N} of which is minimal after such a heat treatment, in particular less than 20% and preferably less than 15%.

Of course, according to a property essential to their potential of use, the stacks of thin layers with which the glazings according to the invention are provided also have to be sufficiently resistant mechanically, in particular if they have to be positioned on an external face of the glazing. They must in particular be resistant to the scratches which may be brought about by the various means used to clean them.

In the end, a glazing according to the invention thus advantageously makes it possible to select the radiation passing through it by favoring the transmittance of the light waves, that is to say the wavelength of which is between approximately 380 and 780 nm, while selectively reflecting a greater portion of the infrared radiation, that is to say the wavelength of which is greater than 780 nm, in particular the near infrared radiation, that is to say the wavelength of which is between approximately 780 nm and approximately 1400 nm.

According to the invention, it is thus possible to maintain high illumination of the room or of the compartment protected by the glazing while minimizing the amount of heat entering therein due to the solar radiation in sunny weather, the low emissive nature of which additionally makes it possible, in cold weather, to minimize the loss of heat through the glazing.

According to another advantage of the present invention, they are also much less sensitive chemically, in particular toward moisture, and can thus be positioned on an external face of a multiple glazing or on one of the faces of a single glazing, in particular its face 2 (that is to say, that turned toward the inside).

More specifically, the present invention relates to a solar control glazing comprising a glass substrate provided, on one of its faces, with a stack of layers having a solar protection function, in which the stack comprises the sequence of the following layers, starting from the surface of the glass substrate:
a lower layer for protecting the upper layers against the migration of the alkali metal ions resulting from the glass substrate, with a thickness of between 25 and 100 nm, preferably between 40 and 90 nm,
a layer of an indium tin oxide (ITO), with a thickness of between 100 and 250 nm, preferably between 100 and 200 nm,
an upper layer for protecting the ITO layer against atmospheric oxygen, in particular during a heat treatment, such as a tempering or an annealing, the upper layer having a thickness of between 25 and 100 nm, preferably between 40 and 90 nm,
said upper and lower layers are essentially composed of a dielectric material chosen from a silicon nitride, an aluminum nitride or their mixture,
intermediate layers made from a chromium-comprising metal, which layers are optionally partially or completely oxidized and/or nitrided, are positioned on either side of and in contact with said ITO layer, the thickness of said intermediate layers being between 0.5 and 3 nanometers.

The expression “which are optionally partially or completely oxidized and/or nitrided” is understood to mean that the intermediate layers, conventionally deposited initially in the form of entirely metallic layers by conventional cathode sputtering techniques, can then potentially be oxidized or nitrided, partially or completely, under the effect of the various depositions of the layers or also of the heat treatments carried out subsequently. For example, a nitridation of the intermediate metallic layer is possible according to the invention when a nitride-comprising layer of the stack is deposited subsequently by reactive sputtering in the presence of nitrogen, as for the case of the deposition of the upper protective layer made of silicon nitride. Likewise, without departing from the scope of the invention, a subsequent oxidation of the intermediate metallic layer is possible during the magnetron deposition of the ITO layer in the presence of oxygen or also during a subsequent heat treatment, after deposition of the complete stack, as is indicated above.

Within the meaning of the present invention, the term “indium tin oxide” or “tin-doped indium oxide” (ITO) is understood to mean a mixed oxide or a mixture obtained from indium(III) oxide (In₂O₃) and tin(IV) oxide (SnO₂), preferably in the proportions by weight of between 70% and 95% for the first oxide and 5% to 20% for the second oxide. A typical proportion by weight is approximately 90% by weight of In₂O₃ for approximately 10% by weight of SnO₂.

According to modes which have given good performances:
The thickness of said intermediate layers is between 1 2.5 nanometers.
The metal comprises at least 10% by weight of Cr, preferably at least 20% by weight of Cr.
The metal is an alloy of nickel and chromium.
The Cr/Ni ratio by weight in the alloy is between 10/90 and 40/60, in particular approximately 20/80.
The lower and upper protective layers are essentially composed of a silicon nitride, optionally doped with an element chosen from Al, Zr or B.
The stack additionally comprises, above the upper layer, a layer made of a dielectric oxide chosen from silicon oxide or a titanium oxide.
The thickness of the layer made of dielectric oxide is between 1 and 15 nanometers, more preferably still between 2 and 10 nanometers.

By way of example, a preferred solar control glazing according to the invention comprises a stack composed of the sequence of the following layers, starting from the surface of the glass substrate:
a lower layer essentially composed of silicon nitride and optionally comprising aluminum, with a thickness of between 30 and 100 nm, preferably between 40 and 90 nm,
a first intermediate layer of an alloy of nickel and chromium, optionally partially or completely oxidized and/or nitrided, with a thickness of between 0.5 and 3 nm, preferably between 1 and 2.5 nm,
an ITO layer with a thickness of between 100 and 250 nm,
a second intermediate layer of an alloy of nickel and chromium, optionally partially or completely oxidized and/or nitrided, with a thickness of between 0.5 and 3 nm, preferably between 1 and 2.5 nm,
an upper layer essentially composed of silicon nitride and optionally comprising aluminum, with a thickness of between 30 and 100 nm.

Preferably, the preceding stack additionally comprises, above the upper layer, a layer made of a dielectric oxide chosen from silicon oxide or a titanium oxide, with a thickness of between 1 and 10 nm.

The examples which follow are given purely by way of illustration and do not limit, under any of the aspects described, the scope of the present invention. For purposes of comparison, all the stacks of the examples which follow are synthesized on simple glass substrates. All the layers of the stacks were deposited according to conventional techniques for depositions under vacuum by magnetron sputtering.

### EXAMPLE 1

In this example according to the invention, a sequence of layers was deposited, according to conventional magnetron techniques, in order to obtain a stack composed of the following sequence of layers:

Glass

| | | | | |
|---|---|---|---|---|
| /Si₃N₄ | /NiCr | /ITO | /NiCr | /Si₃N₄ |
| (56 nm) | (1 nm) | (175 nm) | (1 nm) | (70 nm) |

The stack is deposited on a substrate composed of a glass sheet sold by Saint-Gobain Glass France under the reference Parsol H®, the initial light transmittance of which is equal to 0.74 and the factor g of which is equal to 0.60.

More specifically and in accordance with the known techniques in the field, the successive layers are deposited in specific and successive compartments of the cathode sputtering device, each compartment being specifically provided, according to the layer to be deposited, with an atmosphere and with targets made of metallic Si, made of a nickel/chromium alloy having a tailored ratio or made of ITO.

The layers made of silicon nitride (often denoted Si₃N₄ in the appended formulations for convenience, even if this stoichiometry is not necessarily observed) are deposited in a first compartment of the device starting from a target of metallic silicon dope with 8% by weight of aluminum, in a reactive atmosphere comprising argon and nitrogen, according to the processes and operating conditions well known in the field. The layers made of Si₃N₄ thus comprise a small amount of aluminum.

The metallic NiCr layers are obtained by sputtering a target made of NiCr alloy (80% by weight of Ni and 20% by weight of Cr) with a plasma consisting exclusively of argon, according to the processes and operating conditions well known in the field.

The layers made of ITO are obtained by sputtering a target (90% by weight of indium oxide and 10% by weight of tin oxide) in an atmosphere essentially comprising argon and a small part of oxygen, according to the processes and operating conditions well known in the field.

The substrate provided with its stack was subsequently subjected to a heat treatment which consists in heating at 620° C. for 8 minutes, followed by a tempering.

The T_{L} and g factors are measured on the glazing according to the invention in order to determine the selectivity thereof.

The emissivity at normal incidence ∈_{N} is also measured on the internal face of the substrate covered with the stack of layers, according to the conditions described in the standard ISO 10292 (1994), Annex A.

### EXAMPLE 2

### Comparative

According to this implementation, the preparation was carried out in an identical way to example 1 in the same device and according to the same processes and a substantially identical stack was obtained, with the exception that the layers made of NiCr were not deposited. The stack is thus composed of the following sequence of layers:

Glass

| | | |
|---|---|---|
| /Si₃N₄ | /ITO/ | Si₃N₄ |
| (56 nm) | (175 nm) | (70 nm) |

The T_{L}, g and ∈_{N} factors were measured on this glazing under the same conditions as above.

### EXAMPLE 3

### According to the Invention

In this example, the preparation was carried out in an identical way to example 1 and a substantially identical stack was obtained, except that the layers made of NiCr exhibit a thickness of 1.6 nm. The stack is thus composed of the following sequence of layers:

Glass

| | | | | |
|---|---|---|---|---|
| /Si₃N₄ | /NiCr | /ITO | /NiCr | /Si₃N₄ |
| (56 nm) | (1.6 nm) | (175 nm) | (1.6 nm) | (70 nm) |

The T_{L}, g and ∈_{N} factors were measured on this glazing under the same conditions as above.

### EXAMPLE 4

### According to the Invention

In this example, the preparation was carried out in an identical way to example 1 and a substantially identical stack was obtained, except that the layers made of NiCr exhibit a thickness of 2.5 nm. The stack is thus composed of the following sequence of layers:

Glass

| | | | | |
|---|---|---|---|---|
| /Si₃N₄ | /NiCr | /ITO | /NiCr | /Si₃N₄ |
| (56 nm) | (2.5 nm) | (175 nm) | (2.5 nm) | (70 nm) |

The T_{L}, g and ∈_{N} factors were measured on this glazing under the same conditions as above.

### EXAMPLE 5

### Comparative

In this example, the preparation was carried out in an identical way to example 1 and a substantially identical stack was obtained, except that the layers made of NiCr exhibit a thickness of 4.0 nm. The stack is thus composed of the following sequence of layers:

Glass

| | | | | |
|---|---|---|---|---|
| /Si₃N₄ | /NiCr | /ITO | /NiCr | /Si₃N₄ |
| (56 nm) | (4.0 nm) | (175 nm) | (4.0 nm) | (70 nm) |

The T_{L}, g and ∈_{N} factors were measured on this glazing under the same conditions as above.

The characteristics of the various glazings obtained are given in the following table 1:

TABLE 1

| | Example | Example | Example | Example | Example |
|---|---|---|---|---|---|
| | 1 | 2 | 3 | 4 | 5 |
| IR refl. | ITO | ITO | ITO | ITO | ITO |
| layer | | | | | |
| Thickness | 175 | 175 | 175 | 175 | 175 |
| (nm) refl. | | | | | |
| layer | | | | | |
| NiCr layers | yes | no | yes | yes | yes |
| Thickness | 1 | — | 1.6 | 2.5 | 4.0 |
| (nm) NiCr | | | | | |
| layers | | | | | |
| T_{L} (%) | 55 | 63 | 49 | 46 | 34 |
| g (%) | 42 | 46 | 39 | 38 | 31 |
| Selectivity | 1.31 | 1.37 | 1.25 | 1.21 | 1.10 |
| (T_{L}/g) | | | | | |
| ε_{N} (%) | 13 | 16 | 13 | 16 | 13 |
| Visual | Trans- | Haze on | Trans- | Very light | Haze on |
| appearance | parent | the edges | parent | haze on | the edges |
| | | | | the edges | |

The comparison of the data given in table 1 shows that the comparative stack according to example 2 exhibits the best selectivity but also a haze fully visible on the edges of the sample, which renders the use of such a glazing impossible. The deposition of a thicker layer of NiCr according to example 4 is reflected in addition by a substantial decrease in the selectivity, due to a substantial fall in the light transmittance.

### Scratch Resistance Tests:

The scratch resistance of the stacks according to examples 1 to 5 is measured according to the EST (Erichsen Scratch Test) technique. It concerns giving the value of the applied force necessary, in newtons, to produce a scratch in the stack when the test is carried out (Van Laar tip, steel ball). The value selected is the first value which has resulted in a continuous scratch visible to the naked eye.

The value given in the following table 2 is thus the force exerted (in newtons) which has resulted in the appearance of continuous scratches.

TABLE 2

| | Example 2 | Example 3 | Example 4 | Example 5 |
|---|---|---|---|---|
| Force exerted (N) | 0.2 | 0.6 | 2.0 | 2.0 |

The data given in table 2 show that the stacks provided with NiCr layers exhibit a substantially improved mechanical strength in comparison with the stack according to example 2 devoid of such layers.

### EXAMPLES 6 AND 7

### Comparative

In these examples, the preparation was carried out in an identical way to example and a substantially identical stack was obtained, except that the layers made of NiCr of example 1 are replaced with layers made of metallic titanium with a thickness respectively of 1.6 and 4.0 nm, obtained by sputtering of targets this time made of titanium, in an argon atmosphere.

The stack according to example 6 is composed of the following sequence of layers:

Glass

| | | | | |
|---|---|---|---|---|
| /Si₃N₄ | /Ti | /ITO | /Ti | /Si₃N₄ |
| (56 nm) | (1.6 nm) | (175 nm) | (1.6 nm) | (70 nm) |

The stack according to example 7 is composed of the following sequence of layers:

Glass

| | | | | |
|---|---|---|---|---|
| /Si₃N₄ | /Ti | /ITO | /Ti | /Si₃N₄ |
| (56 nm) | (4.0 nm) | (175 nm) | (4.0 nm) | (70 nm) |

The T_{L}, g and ∈_{N} factors and the scratch resistance of the coatings were measured on this glazing under the same conditions as above. The results are combined in table 3 below:

TABLE 3

| | Example 6 | Example 7 |
|---|---|---|
| IR refl. layer | ITO | ITO |
| Thickness (nm) | 175 | 175 |
| refl. layer | | |
| Ti layers | yes | yes |
| Thickness (nm) | 1.6 | 4.0 |
| Ti layers | | |
| T_{L} (%) | 53 | 30 |
| g (%) | 40 | 29 |
| Selectivity | 1.32 | 1.05 |
| (T_{L}/g) | | |
| ε_{N} (%) | 14 | 15 |
| Visual | Transparent | Haze + brown |
| appearance | | specks |
| Force exerted | 0.2 | 0.1 |
| for scratching | | |
| (N) | | |

It is clearly seen that, in contrast to the layers made of NiCr, the layers made of Ti positioned on either side of the active ITO reflective layer do not this time contribute any improvement in the scratch resistance performance of the stack.

1. A solar control glazing, comprising:
a glass substrate provided, on a face thereof, with a stack of layers configured for solar protection,
wherein the stack comprises a sequence of layers, starting from a surface of the glass substrate, of:
a lower layer configured for protecting upper layers against migration of alkali metal ions from the glass substrate, with a thickness of between 25 and 100 nm,
a layer of an indium tin oxide (ITO), with a thickness of between 100 and 250 nm,
an upper layer configured for protecting the ITO layer against atmospheric oxygen, the upper layer having a thickness of between 25 and 100 nm,
wherein the upper and lower layers consist essentially of a silicon nitride, an aluminum nitride, or a mixture thereof, as a dielectric material,
the stack further comprises intermediate layers of a chromium-comprising metal, optionally partially or completely oxidized and/or nitrided, on either side of and in contact with the ITO layer, and
a thickness of each intermediate layer of the intermediate layers is between 0.5 and 3 nanometers.

2. The glazing of claim 1, wherein the thickness of each intermediate layer of the intermediate layers is between 1 and 2.5 nanometers.

3. The glazing of claim 1, wherein the metal comprises at least 10% by weight of Cr.

4. The glazing of claim 1, wherein the metal is an alloy of nickel and of chromium.

5. The glazing of claim 4, wherein a Cr/Ni ratio by weight in the alloy is between 10/90 and 40/60.

6. The glazing of claim 1, wherein the lower and upper protective layers consist essentially of a silicon nitride, optionally doped with Al, Zr, or B.

7. The glazing of claim 1, further comprising, above the upper layer, a layer of silicon oxide or a titanium oxide as a dielectric oxide.

8. The glazing of claim 7, wherein a thickness of the layer of dielectric oxide is between 1 and 15 nanometers.

9. The glazing of claim 1, wherein the comprises a sequence of layers, starting from a surface of the glass substrate, of:
a lower layer consisting essentially of silicon nitride and optionally aluminum, with a thickness of between 30 and 100 nm,
a first intermediate layer of an alloy of nickel and chromium, optionally partially or completely oxidized and/or nitrided, with a thickness of between 0.5 and 3 nm,
an ITO layer with a thickness of between 100 and 250 nm,
a second intermediate layer of an alloy of nickel and chromium, optionally partially or completely oxidized and/or nitrided, with a thickness of between 0.5 and 3 nm,
an upper layer consisting essentially of silicon nitride and optionally aluminum, with a thickness of between 30 and 100 nm.

10. The glazing of claim 9, further comprising, above the upper layer, a layer of silicon oxide or a titanium oxide as a dielectric oxide, with a thickness of between 1 and 10 nm.
